(19) United States
(12) Patent Application Publication
(10) Pub. No.: US 2014/0125831 A1
(43) Pub. Date: May 8, 2014

(54) ELECTRONIC DEVICE AND RELATED METHOD AND MACHINE READABLE STORAGE MEDIUM

(71) Applicant: MEDIATEK INC., Hsin-Chu (TW)

(72) Inventor: Chen-Hung Chan, Taoyuan County (TW)

(73) Assignee: MEDIATEK INC., Hsin-Chu (TW)

(21) Appl. No.: 13/669,468

(22) Filed: Nov. 6, 2012

(51) Int. Cl. H04N 5/228; G03B 13/00

(52) U.S. Cl. 348/222.1; 348/345; 348/E05.031

(57) ABSTRACT

An embodiment of the invention provides a method performed by an electronic device. According to the method, the electronic device first receives a shutter instruction. Then, in response to the shutter instruction, the electronic device automatically captures a plurality of images of a scene using a plurality of different focal distances, respectively.

### BACKGROUND

1. Technical Field

The invention relates generally to an electronic device capable of capturing images, and more particularly, to an electronic device capable of capturing images and allowing its user to refocus captured images.

2. Related Art

An electronic device capable of capturing images has a set of lens that guides some of the light coming from a scene onto an image sensor. If the lens set has at least one piece of lens that is movably mounted in the electronic device, the electronic device may have a focal distance that is adjustable. Even when the electronic device remains still, the electronic device's focus may be changed to different parts of the scene by changing the position of the movable lens within the electronic device.

If objects in the scene have different distances away from the electronic device, the electronic device may need to focus on only some parts of the scene and leave the other parts out of focus. The out-of-focus parts of the scene may seem blurred in the captured image and the user may not be able to refocus, i.e. change the focus of, the already captured image.

### SUMMARY

An embodiment of the invention provides a method performed by an electronic device. According to the method, the electronic device first receives a shutter instruction. Then, in response to the shutter instruction, the electronic device automatically captures a plurality of images of a scene using a plurality of different focal distances, respectively.

An embodiment of the invention provides an electronic device. The electronic device includes a user interface, an actuator, an image sensor, a storage device, and a processor. The processor is coupled to the user interface, the actuator, the image sensor, and the storage device. The processor is configured to: in response to a shutter instruction the user interface receives, automatically control the actuator to enable the electronic device to get a plurality of focal distances, the image sensor to capture a plurality of images of a scene using the focal distances, respectively, and the storage device to store the images.

An embodiment of the invention provides a machine readable storage medium. The machine readable storage medium stores executable program instructions which when executed cause an electronic device to perform a method. The method includes: receiving a shutter instruction; and automatically capturing a plurality of images of a scene using a plurality of different focal distances, respectively, in response to the shutter instruction.

Other features of the present invention will be apparent from the accompanying drawings and from the detailed description which follows.

### BRIEF DESCRIPTION OF THE DRAWINGS

The invention is fully illustrated by the subsequent detailed description and the accompanying drawings, in which like references indicate similar elements.

FIG. 1 shows a simplified block diagram of an electronic device according to an embodiment of the invention.

FIG. 2 shows a simplified flowchart of a method the electronic device of FIG. 1 performs.

FIG. 3 shows three simplified schematic diagrams of three images the electronic device of FIG. 1 captures for an exemplary scene.

FIG. 4 shows a simplified flowchart of a method an electronic device performs to align images of a scene in post-production.

FIG. 5 shows a simplified flowchart of a method an electronic device performs in displaying images of a scene.

FIG. 6 shows a simplified flowchart of another method an electronic device performs in displaying the images of the scene.

FIG. 7 illustrates how an image may be divided into four rectangular areas of the same size.

FIG. 8 shows an exemplary line chart of focusing values of four areas in the images depicted in FIG. 3.

### DETAILED DESCRIPTION

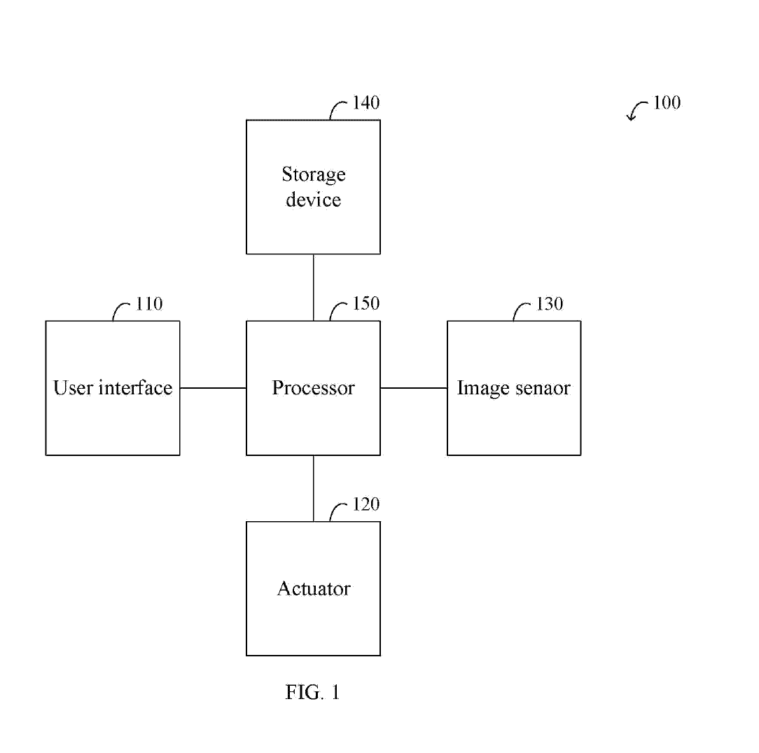

FIG. 1 shows a simplified block diagram of an electronic device according to an embodiment of the invention. To name a few examples, the electronic device 100 may be a digital single-lens reflex (DSLR) camera, a digital compact camera, or any electronic device that is capable of capturing images, such as a smart phone or a tablet computer. In addition to other components omitted from FIG. 1 for the sake of simplicity, the electronic device 100 further includes a user interface 110, an actuator 120, an image sensor 130, a storage device 140, and a processor 150.

The user interface 110 allows the electronic device 100 to interact with the user. For example, to receive shutter instructions or other kinds of instructions from the user, the user interface 110 may include or be connected to a mechanical shutter button, a touch pad, or a touch screen, or even a microphone for receiving voice commands. To display an image, the user interface 110 may include or be connected to a screen, a touch screen, a computer monitor, a television, or a projector. The actuator 120 may enable the electronic device 100 to get any one of several different focal distances, e.g. by changing the position of the image sensor 130 or a lens of the electronic device 100. The image sensor 130 may capture an image of a scene by detecting light that comes from the scene and eventually reaches the image sensor 130. The storage device 140 may store images captured by the image sensor 130. Furthermore, the storage device 140 may storage some executable program instructions. When being executed by the processor 150, some of the program instructions may cause the electronic device 100 to perform any of the methods described below. As a result, the processor 150 may be configured to control the components of the electronic device 100 to perform any of the methods described below. The program instructions may also be stored in another machine readable storage medium, such as an optical disc, a hard disk drive, a solid-state drive, or a flash memory.

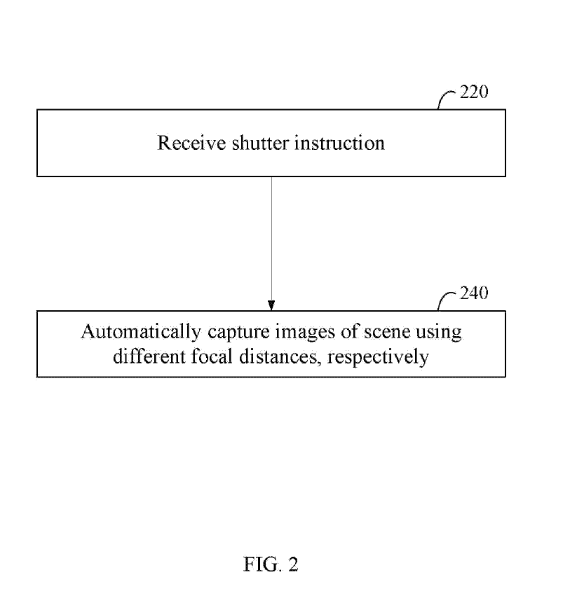

FIG. 2 shows a simplified flowchart of a method the electronic device 100 performs. First, at step 220, the electronic device 100 receives a shutter instruction through the user interface 110. Then, in response to the shutter instruction, the processor 150 automatically control the components of the electronic device 100 to capture a plurality of images of a scene using a plurality of different focal distances, respectively, at step 240. Each of the images may be stored as an independent image file and be associated with the image files of other images. In other words, the image files of the images need not to be blended into a single file. The different focal distances may include a predetermined subset of the followings: a macro focal distance, several intermediate focal distances, and an infinite focal distance. If the different focal distances are not pre-determined, each of the used focal distances may be one that makes at least a part of the scene in focus, i.e. appears clear.

The electronic device 100 may complete step 240 within a few seconds, without the user's involvement. In other words, the electronic device 100 may perform step 240 devoid of user intervention. This feature may reduce the user's waiting time and the risk that the objects in the scene or the electronic device 100 moves during step 240.

For example, at step 240, the processor 150 may automatically control the actuator 120 to enable the electronic device 100 to get the focal distances one by one, the image sensor 130 to capture the images at the focal distances, respectively, and the storage device 140 to store the images. In doing so, the processor 150 may control the actuator 120 to start from a maximum one of the focal distances and gradually move toward a minimum one of the focal distances, or from the minimum focal distance toward the maximum one.

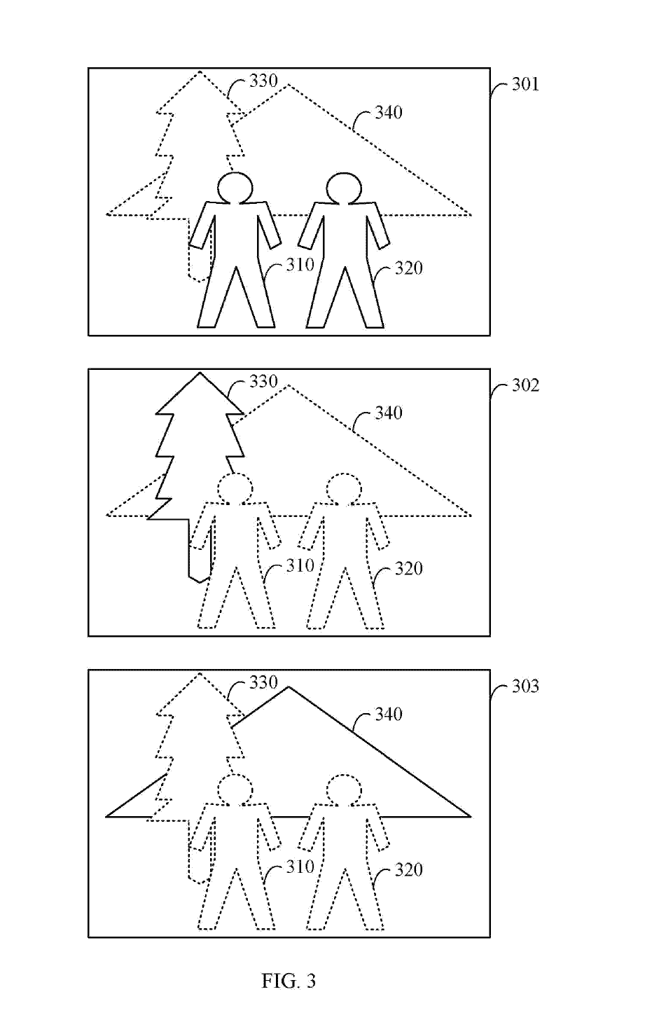

FIG. 3 shows three simplified schematic diagrams of three images the electronic device 100 captures at step 240 for an exemplary scene. The exemplary scene mainly has four objects, including two persons 310 and 320, a tree 330, and a mountain 340. Among the four objects, the two persons 310 and 320 are the closest to the electronic device 100 and the mountain 340 is the farthest from the electronic device 100. When capturing image 301, the electronic device 100 has a focal distance that is equal to or close to the distance between the person 310/320 and the electronic device 100. As a result, in image 301, the persons 310 and 320 are relatively in focus while the tree 330 and the mountain 340 are relatively out of focus. When capturing image 302, the electronic device 100 has a focal distance that is equal to or close to the distance between the tree 330 and the electronic device 100. As a result, in image 302, the tree 330 is relatively in focus while the persons 310 and 320 and the mountain 340 are relatively out of focus. When capturing image 303, the electronic device 100 has a focal distance that is equal to or close to the distance between the mountain 340 and the electronic device 100. As a result, in image 303, the mountain 340 is relatively in focus while the persons 310 and 320 and the tree 330 are relatively out of focus. Please note that in these schematic diagrams, solid lines are used to represent the boundaries of objects that are relatively in focus, while broken lines are used to represent the boundaries of objects that are relatively out of focus.

An electronic device having access to the images captured at step 240 may conduct some post-production activities on the images. To name a few examples, the electronic device may be the electronic device 100, or another digital camera, a smart phone, a computer of any type, or a smart television that has access to the images.

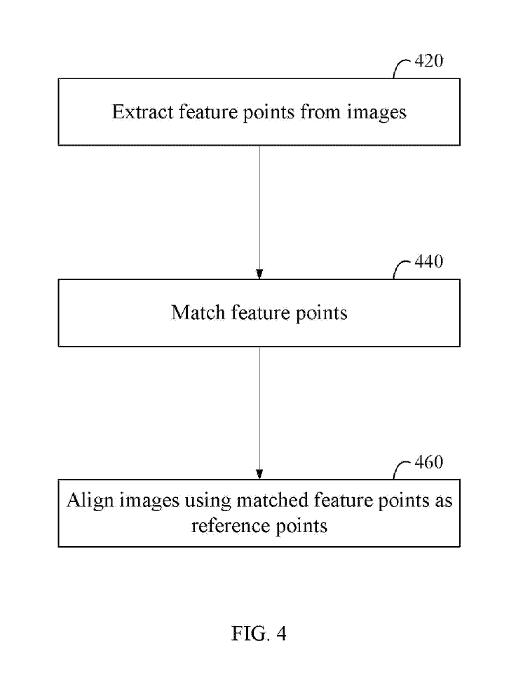

Post-production may be useful when a common object in the scene appears at different positions in the images. There are several potential causes of this situation, such as the fact that the electronic device 100's angle of view may change with the focal distance, that the electronic device 100 fails to remain still at step 240, and that the object is moving when the electronic device 100 is performing step 240. FIG. 4 shows a simplified flowchart of a method an electronic device performs to align images in post-production. At step 420, the electronic device extracts feature points from two of the images. Then, at step 440, the electronic device matches the feature points of the two images. Next, at step 460, the electronic device aligns the two images using the matched feature points as reference points. In aligning the two images, the electronic device may need to crop and offset the images to generate two new images that are better aligned with each other.

For example, at step 420, the electronic device may extract a first feature point from coordinates (x1, y1) of image 301 and a second feature point from coordinates (x2, y2) of image 302. Then, at step 440, the electronic device may match the two feature points because they seem to represent to the same point in the scene, such as the tip of the mountain 340. Next, at step 460, the electronic device may align images 301 and 302 by moving the both the first and second feature points to coordinates (x3, y3). After step 460, the electronic device may have a new image generated based on image 301 and a new image generated based on image 302, and the two new images are better aligned with each other.

As a second example of the post-production activities, an electronic device may use two images of the scene to interpolate/extrapolate another image of the scene. The two images may be two of the images captured at step 240, or two aligned images of the scene. The two images and the interpolated/extrapolated image are of the same scene, but correspond to three different focal distances.

Furthermore, with multiple images of the scene but at different focal distances, the electronic device may give its user more choices and let the user to freely select therefrom. In effect, this allows the user to refocus a photo after the photo has been taken and the user is no longer before the scene. For example, seeing one of the images displayed by the electronic device, the user may instruct the electronic device to display another image of the same scene that is taken at another focal distance.

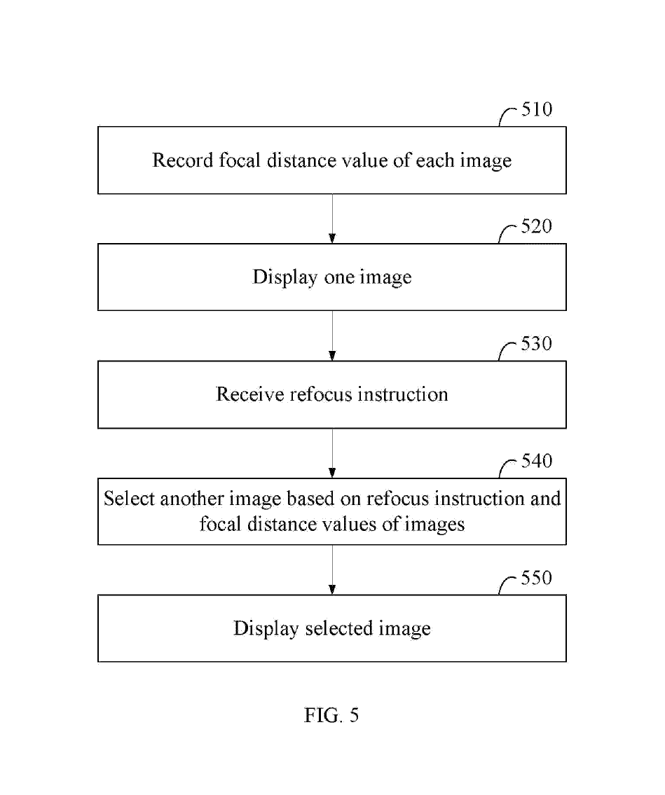

FIG. 5 shows a simplified flowchart of a method an electronic device performs in displaying images of the scene to its user. At step 510, the electronic device records a focal distance value of each of the images, wherein the focal distance value corresponds to the focal distance used in capturing the image. For example, the focal distance values recorded for images 301, 302, and 303 may be lens positions a, b, and c used in capturing the images, respectively. As another example, the focal distance values recorded for images 301, 302, and 303 may be focal distance x, y, and z respectively, wherein x is smaller than y and y is smaller than z. If the electronic device is the electronic device 100, the processor 150 may control the execution of step 510 and the aforementioned step 240 simultaneously.

At step 520, the electronic device display one, e.g. a random one, of the images. Then, at step 530, the electronic device receives a refocus instruction from the user. The refocus instruction may instruct the electronic device to display another one of the images that has a either a shorter or a longer focal distance than that of the image displayed at step 520. Next, at step 540, the electronic device selects another one of the images based on the refocus instruction and the focal distance values of the images. Finally, at step 550, the electronic device displays the selected image in place of the image displayed at step 520.

For example, if the electronic device displays image 302 at step 520, it may allow the user to issue a refocus instruction to either decrease or increase the focal distance. If the user issues a refocus instruction to decrease the focal distance at step 530, the electronic device may select image 301 at step 540 and display image 301 at step 550. If the user issues a refocus instruction to increase the focal distance at step 530, the electronic device may select image 303 at step 540 and display image 303 at step 550.

If the electronic device displays image 301 at step 520, it may allow the user to issue a refocus instruction to increase (but not decrease) focal distance. If the user issues a refocus instruction to increase the focal distance at step 530, the electronic device may select image 302 at step 540 and display image 302 at step 550. If the electronic device displays image 303 at step 520, it may allow the user to issue a refocus instruction to decrease (but not increase) focal distance. If the user issues a refocus instruction to decrease the focal distance at step 530, the electronic device may select image 302 at step 540 and display image 302 at step 550.

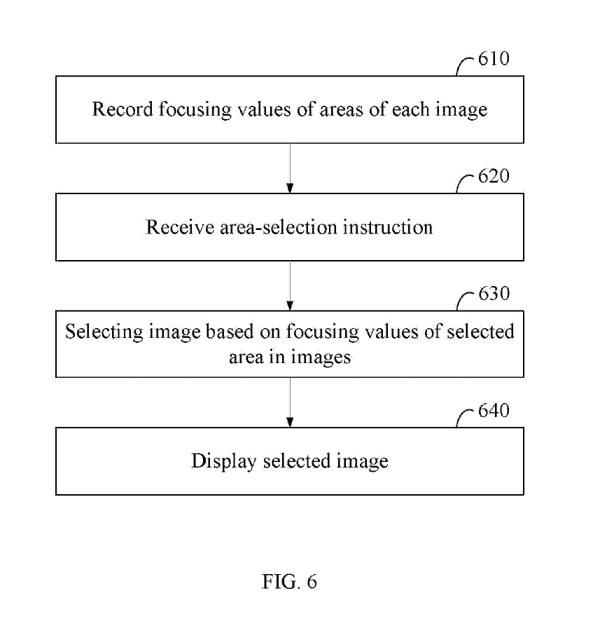

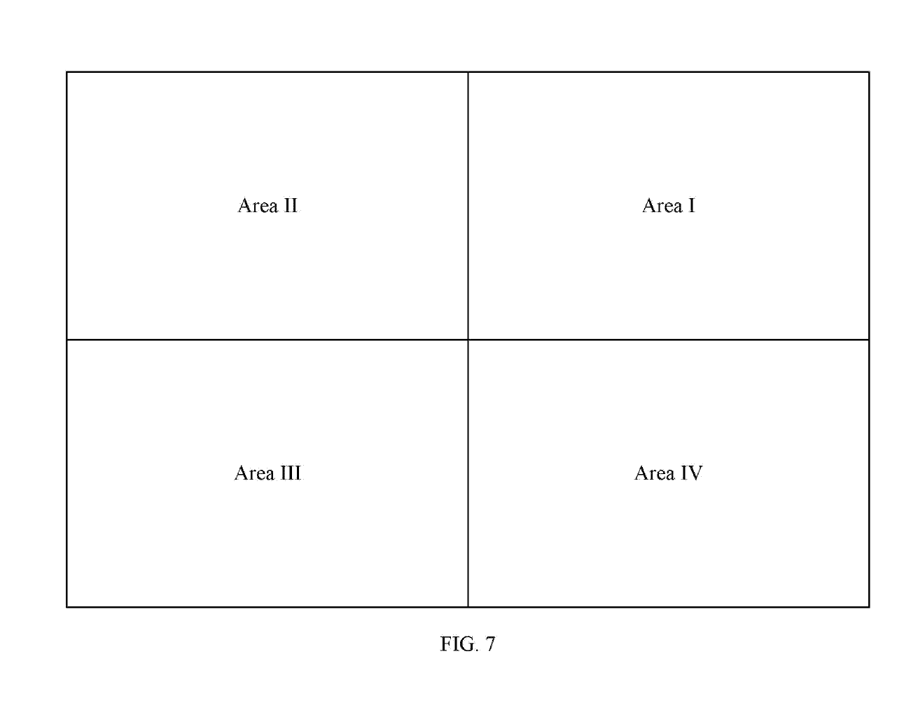

FIG. 6 shows a simplified flowchart of another method an electronic device performs in displaying images of the scene to its user. At step 610, the electronic device records a plurality of focusing values of a plurality of areas, respectively, of each of the images. If the electronic device is the electronic device 100, the processor 150 may control the execution of step 610 and the aforementioned step 240 simultaneously. FIG. 7 illustrates how each image may be divided into four rectangular areas of the same size. These areas include area I at the upper right corner, area II at the upper left corner, area III at the bottom left corner, and area IV at the bottom right corner.

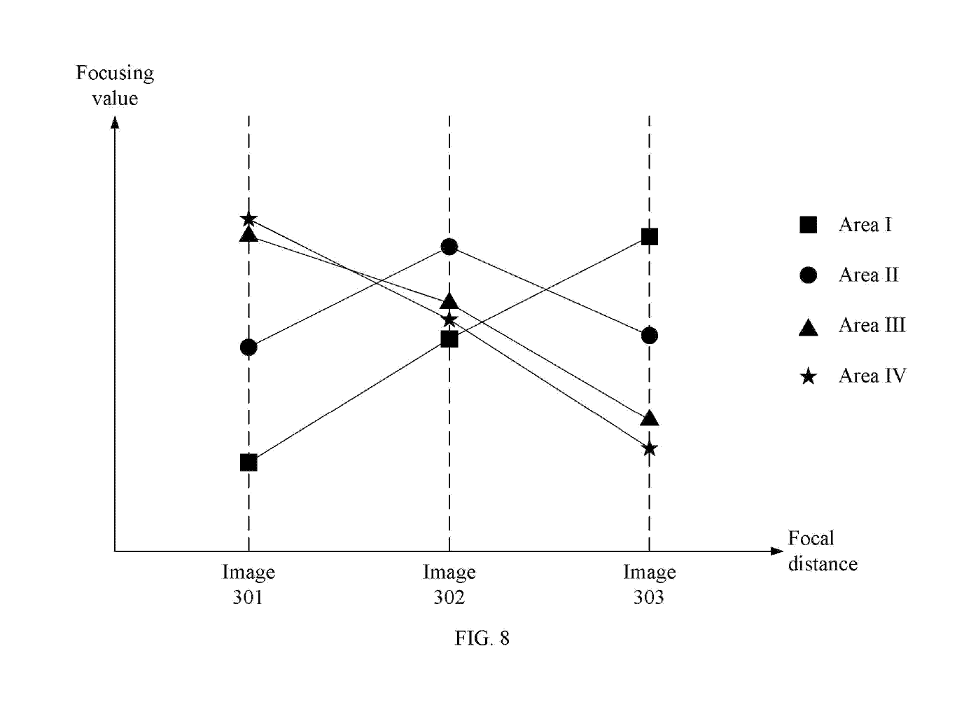

The focusing value of an area of image indicates to what extent the visual content therein is in focus. For example, the larger the focusing value, the clearer the visual content may seem; the smaller the focusing value, the more blurred the visual content may seem. To name a few examples, the focusing value may be, or be generated based upon, a contrast value or a sharpness value of the visual content. FIG. 8 shows an exemplary line chart of the focusing values of the four areas in images 301, 302, and 303.

Then, at step 620, the electronic device receives an area-selection instruction that selects one of the areas. Next, at step 630, the electronic device selects one from the images based on the focusing values of the selected area in the images. Finally, at step 640, the electronic device displays the selected image.

For example, to facilitate step 620, the electronic device may display a random one of images 301, 302, and 303 on a touch screen and allows the user to use the touch screen to select one of areas I, II, Ill, and IV. For example, if the user selects area I, the electronic device may elect one from images 301, 302, and 303 at step 360 based on the focusing values represented by the rectangles in FIG. 8. As another example, if the user selects area III, the electronic device may elect one from images 301, 302, and 303 at step 630 based on the focusing values represented by the triangles in FIG. 8. As the exemplary line chart indicates, areas I, II, Ill, and IV have their largest focusing values in images 303, 302, 301, and 301, respectively. Therefore, if the user selects area I, II, Ill, or IV, at step 620, the electronic device may select image 303, 302, 301, or 301, respectively at step 630 and then display the selected image at step 640. For example, the user may want to select area I, II, Ill, or IV, if he/she is interested in the mountain 340, the tree 330, the person 310, or the person 320, respectively.

The aforementioned embodiments do not require expensive hardware, such as complicated optical system. Without much additional hardware costs, the embodiments may allow a user to refocus a photo after the photo has already been taken.

In the foregoing detailed description, the invention has been described with reference to specific exemplary embodiments thereof. It will be evident that various modifications may be made thereto without departing from the spirit and scope of the invention as set forth in the following claims. The detailed description and drawings are, accordingly, to be regarded in an illustrative sense rather than a restrictive sense.

What is claimed is:

1. A method performed by an electronic device capable of capturing images, comprising:
receiving a shutter instruction; and
automatically capturing a plurality of images of a scene using a plurality of different focal distances, respectively, in response to the shutter instruction.

2. The method of claim 1, wherein the step of automatically capturing the images is performed devoid of user intervention.

3. The method of claim 1, wherein the step of automatically capturing the images comprises:
automatically enabling the electronic device to get the focal distances one by one and capturing and storing the images of the scene one by one.

4. The method of claim 1, further comprising:
recording a focal distance value of each of the images, wherein the focal distance value corresponds to the focal distance used in capturing the image;
displaying one of the images;
receiving a refocus instruction;
selecting another one of the images based on the refocus instruction and the focal distance values of the images; and
displaying the selected image.

5. The method of claim 1, further comprising:
recording a plurality of focusing values of a plurality of areas, respectively, of each of the images;
receiving an area-selection instruction that selects one of the areas;
selecting one from the images based on the focusing values of the selected area in the images; and
displaying the selected image.

6. The method of claim 1, further comprising:
extracting feature points from at least two of the images;
matching the feature points; and
aligning the at least two images using the matched feature points as reference points.

7. The method of claim 1, further comprising:
generating an additional image of the scene based on two of the images of the scene through interpolation or extrapolation, wherein the additional image and the two images correspond to three different focal distances.

8. An electronic device capable of capturing images, comprising:
a user interface;
an actuator;
an image sensor;
a storage device; and
a processor, coupled to the user interface, the actuator, the image sensor, and the storage device, and configured to:
in response to a shutter instruction the user interface receives, automatically control the actuator to enable the electronic device to get a plurality of focal distances, the image sensor to capture a plurality of images of a scene using the focal distances, respectively, and the storage device to store the images.

9. The electronic device of claim 8, wherein in response of the shutter instruction, the processor is configured to control the actuator, the image sensor, and the storage device devoid of user intervention.

10. The electronic device of claim 8, wherein the processor is further configured to:
control the storage device to record a focal distance value of each of the images, wherein the focal distance value corresponds to the focal distance used in capturing the image;
control the user interface to display one of the images;
control the user interface to receive a refocus instruction;
select another one of the images based on the refocus instruction and the focal distance values of the images; and
control the user interface to display the selected image.

11. The electronic device of claim 8, wherein the processor is further configured to:
control the storage device to record a plurality of focusing values of a plurality of areas, respectively, of each of the images;
control the user interface to receive an area-selection instruction that selects one of the areas;
select one from the images based on the focusing values of the selected area in the images; and
control the user interface to display the selected image.

12. The electronic device of claim 8, wherein the processor is further configured to:
extract feature points from at least two of the images;
match the feature points; and
align the at least two images using the matched feature points as reference points.

13. The electronic device of claim 8, wherein the processor is further configured to:
generate an additional image of the scene based on two of the images of the scene through interpolation or extrapolation, wherein the additional image and the two images correspond to three different focal distances.

14. A machine readable storage medium storing executable program instructions which when executed cause an electronic device to perform a method comprising:
receiving a shutter instruction; and
automatically capturing a plurality of images of a scene using a plurality of different focal distances, respectively, in response to the shutter instruction.

15. The machine readable storage medium of claim 14, wherein the step of automatically capturing the images is performed devoid of user intervention.

16. The machine readable storage medium of claim 14, wherein the step of automatically capturing the images comprises:
automatically enabling the electronic device to get the focal distances one by one and capturing and storing the images of the scene one by one.

17. The machine readable storage medium of claim 14, wherein the method further comprises:
recording a focal distance value of each of the images, wherein the focal distance value corresponds to the focal distance used in capturing the image;
displaying one of the images;
receiving a refocus instruction;
selecting another one of the images based on the refocus instruction and the focal distance values of the images; and
displaying the selected image.

18. The machine readable storage medium of claim 14, wherein the method further comprises:
recording a plurality of focusing values of a plurality of areas, respectively, of each of the images;
receiving an area-selection instruction that selects one of the areas;
selecting one from the images based on the focusing values of the selected area in the images; and
displaying the selected image.

19. The machine readable storage medium of claim 14, wherein the method further comprises:
extracting feature points from at least two of the images;
matching the feature points; and
aligning the at least two images using the matched feature points as reference points.

20. The machine readable storage medium of claim 14, wherein the method further comprises:
generating an additional image of the scene based on two of the images of the scene through interpolation or extrapolation, wherein the additional image and the two images correspond to three different focal distances.
